(19) United States
(12) Patent Application Publication
(10) Pub. No.: US 2022/0312721 A1
(43) Pub. Date: Oct. 6, 2022

(54) COVER FOR ANIMAL WASTE PIT AREA

(71) Applicant: RLS Enterprises LLC, North Liberty, IA (US)

(72) Inventor: Robert L. Schulty, Wellman, IA (US)

(73) Assignee: RLS Enterprises LLC, North Liberty, IA (US)

(21) Appl. No.: 17/218,338

(22) Filed: Mar. 31, 2021

(51) Int. Cl. A01K 1/01

(52) U.S. Cl. CPC A01K 1/01

(57) ABSTRACT

A pit cover for selectively covering a pit opening which provides access to an animal waste collection area. One or more of the edges may include a flange which a user may grip when lifting or moving the pit cover. The top side includes a plurality of raised ridges extending generally across its surface. The ridges help provide traction for a user walking on the pit cover. The longitudinal axis of one or more of the ridges may be set at an angle relative to the longitudinal axis of the front edge of the pit cover to allow water and other moisture to drain off of the top side. The pit cover may be made from any suitable material, including fiberglass. In embodiments where the pit cover is made from fiberglass, the ridges are part of the fiberglass mold which helps add strength by corrugation.

### BACKGROUND

Ruminant and other similar animals are raised in large numbers for human consumption or for other useful purposes. Raising large numbers of such animals leads to the production of large amounts of solid and liquid waste materials. Typically, this waste material is collected and maintained for some period in animal waste holding pits situated beneath the building or structure in which the animals are housed.

The animal waste is periodically removed from the holding pit by pumping the waste to a truck, lagoon, or other suitable location through a hose. Animal confinement buildings have one or more pit openings around the building's outer perimeter which provide access to the underground pit. The pit openings may have a concrete frame around their perimeter which is angled downward away from the outer wall of the building as shown in FIG. 3. Removable covers are placed over each pit opening to help contain gaseous emissions when access to the pit is not needed, for example, when the pit is not being pumped. The pit cover can be removed and the hose inserted into the pit when desired to pump waste from the pit.

Existing pit covers are typically heavy and difficult for one person to remove from or position over the pit opening. Pit covers do not have a good surface for a user to grab when moving the pit cover.

Before removing a pit cover, there is often a need for someone to climb on the pit cover to unplug an electric fan mounted inside the pit cover. Walking or climbing on pit covers can be dangerous because many existing pit covers have a smooth outer surface. The smooth surface is slippery, especially when they are wet. Further, most pit covers are angled downward away from the building due to the angle of the pit frame as shown in FIG. 3, which adds to the danger and slippery nature of the pit cover's surface.

Pit covers are have a high initial cost. Recently, permeable pit covers have been introduced to the market in an attempt to lower this initial cost. Permeable pit covers allow for rain water to penetrate the surface. As a result of their permeable nature, they are unable to control odors and air emissions as well as the conventional pit covers.

There is therefore a need for an improved pit cover which overcomes these and other deficiencies in the art.

### SUMMARY

One aspect of the invention includes a pit cover for selectively covering a pit opening which provides access to an animal waste collection area which may be positioned under an animal confinement building. The pit cover has a top side, a bottom side, a front edge, and one or more other edges. The front edge has a longitudinal axis and is adapted to be placed against an adjoining surface, which may be the outer wall of the animal confinement building or another intermediate surface extending from the wall of the animal confinement building. In some embodiments the front edge includes a sealing gasket to help create an air and fluid tight seal between the pit cover and the adjoining surface. The top side includes a plurality of raised ridges extending generally across its surface. The ridges help provide traction for a user walking on the pit cover and may have a triangular cross-section. In some embodiments the longitudinal axis of one or more of the ridges is generally parallel with the longitudinal axis of the front edge of the pit cover. In other embodiments the longitudinal axis of one or more of the ridges may be set at an angle relative to the longitudinal axis of the front edge of the pit cover to allow water and other moisture to drain off of the top side. In these embodiments the portions of the ridges closer to the middle of the pit cover are positioned closer to the front edge and the portions of the ridges closer to the other edges of the pit cover may be farther from the front edge. The pit cover may be made from any suitable material, including fiberglass. In embodiments where the pit cover is made from fiberglass, the ridges are part of the fiberglass mold which helps add strength by corrugation. Some embodiments include an opening extending through the pit cover adapted to receive a fan for filtering air into the animal waste collection area.

Another aspect of the invention includes a pit cover for selectively covering a pit opening. The pit cover has a top side, a bottom side, a front edge, and one or more other edges. The front edge has a longitudinal axis. In some embodiments the front edge includes a sealing gasket. The top side includes a plurality of raised ridges extending generally across its surface. The ridges help provide traction for a user walking on the pit cover and may have a triangular cross-section. In some embodiments the longitudinal axis of one or more of the ridges is generally parallel with the longitudinal axis of the front edge of the pit cover. In other embodiments the longitudinal axis of one or more of the ridges may be set at an angle relative to the longitudinal axis of the front edge of the pit cover to allow water and other moisture to drain off of the top side. In these embodiments the portions of the ridges closer to the middle of the pit cover are positioned closer to the front edge and the portions of the ridges closer to the other edges of the pit cover may be farther from the front edge. The pit cover may be made from any suitable material, including fiberglass. In embodiments where the pit cover is made from fiberglass, the ridges are part of the fiberglass mold which helps add strength by corrugation. Some embodiments include an opening extending through the pit cover adapted to receive a fan for filtering air into the animal waste collection area.

### BRIEF DESCRIPTION OF THE DRAWINGS

FIG. 1 is a perspective view of the pit cover.

FIG. 2 is a top view of the pit cover.

FIG. 3 is a perspective view of an exemplary pit having a frame around is perimeter.

FIG. 4 is a bottom view of the pit cover.

FIG. 5 is a bottom view of the pit cover showing the area where the pit frame would contact the underside of the cover when the cover is placed on the pit frame.

FIG. 6 is a bottom view of an alternate embodiment of the pit cover.

FIG. 7 is a perspective view of the sealing gasket along one side of the pit cover.

FIG. 8 is a perspective view of an exemplary shape of the elevated ridges.

### DETAILED DESCRIPTION

The invention generally relates to a pit cover 10 for selectively covering a pit opening 27 which provides access to an animal waste collection area positioned under an animal confinement building 11. The outer wall of an exemplary animal confinement building 11 is shown in FIG. 3 wherein the frame 26 slopes away from the building 11 and surrounds the pit opening 27.

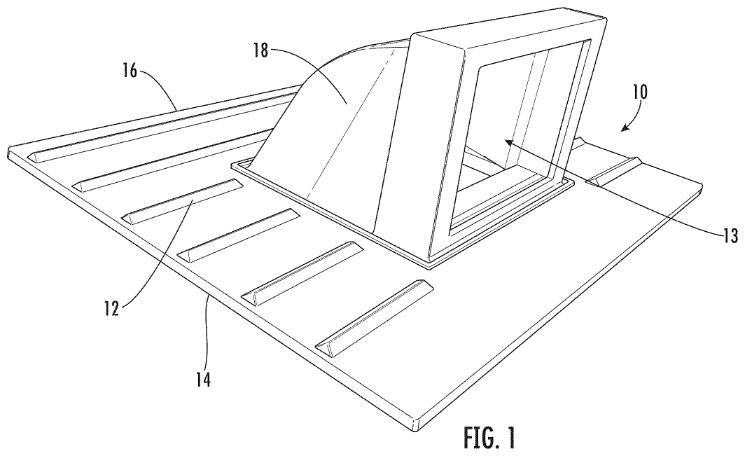

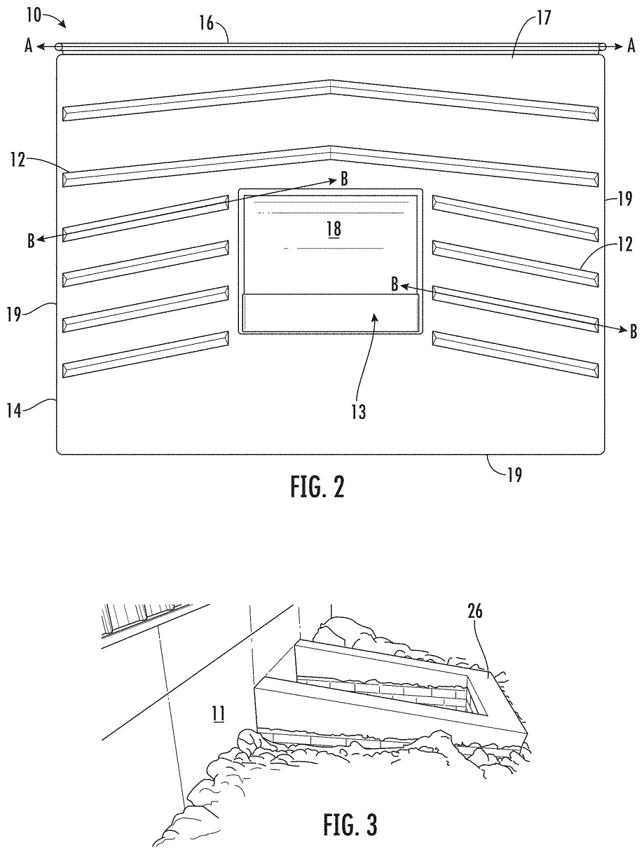

The pit cover 10 has a top side, a bottom side, a front edge 17, and one or more other edges 19. FIGS. 1 and 2 show the top side of the pit cover 10. Some embodiments include an opening 13 extending through the pit cover 10, the opening 13 is adapted to receive a fan (not shown) for filtering air into the animal waste collection area. The front edge has a longitudinal axis A and is adapted to be placed against an adjacent structure, which may be the outer wall of the animal confinement building 11 or another intermediate surface extending from the outer wall of the animal confinement building 11. In some embodiments the front edge 17 includes a sealing gasket 16 to help create an air and fluid tight seal between the pit cover 10 and the adjoining surface. It is desirable to create a seal between the pit cover 10 and the pit frame 26 to help prevent noxious fumes from leaking from the pit and also to help ensure the proper functioning of the air handling system of the building 11.

As also shown in FIGS. 1 and 2, the top side of the pit cover 10 includes a plurality of raised ridges 12 extending generally across its surface. The ridges 12 help provide traction for a user who may be walking on the pit cover 10 to unplug a fan from an electrical outlet or for any other purpose. The ridges 12 may be rounded at their highest elevation or they may have one or more sharp vertices to help provide traction. In some embodiments the ridges 12 have a triangular cross section as shown in FIG. 8. In some embodiments the longitudinal axis of one or more of the ridges 12 is generally parallel with the longitudinal axis A of the front edge of the pit cover 10. As shown best in FIG. 2, in other embodiments the longitudinal axis B of one or more of the ridges 12 may be set at an angle relative to the longitudinal axis A of the front edge 17 of the pit cover 10. The angle allows water and other moisture to drain off of the top side of the pit cover 10. In these embodiments the portions of the ridges 12 closer to the middle of the pit cover 10 are positioned closer to the front edge 17 and the portions of the ridges 12 closer to the other edges 19 of the pit cover 10 are farther from the front edge 17. When the pit cover 10 is positioned on the sloping frame 26 with the gasket 16/front edge 17 positioned against the wall of the building 11, the ridges 12 are angled enough to drain water while also providing traction to anyone walking on the pit cover 10.

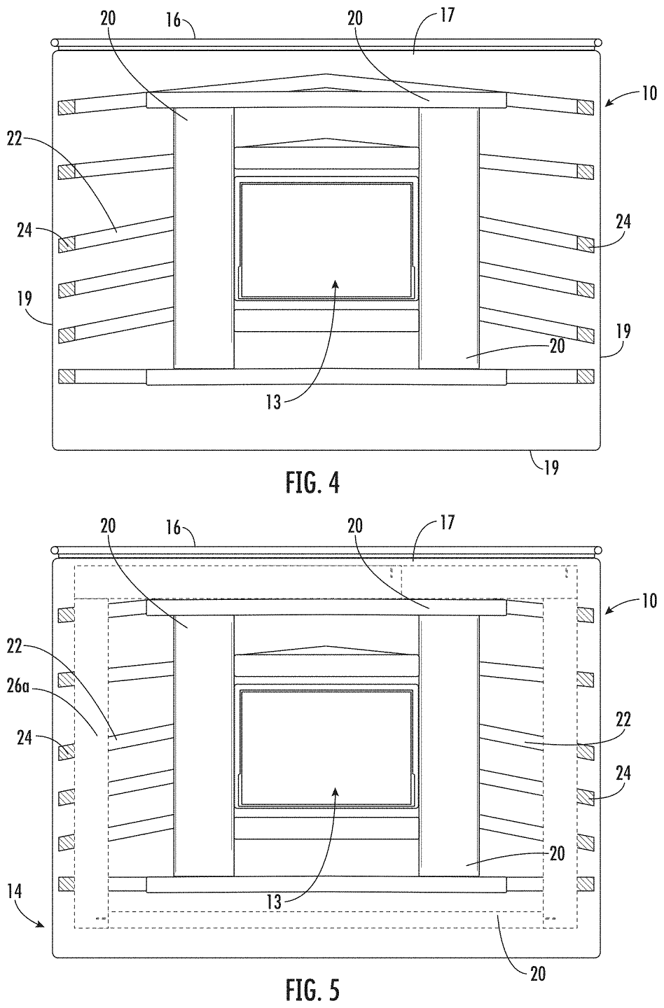

The pit cover 10 may be made from any suitable material, including fiberglass. In embodiments where the pit cover 10 is made from fiberglass, the ridges 12 extending above the top surface having corresponding grooves 22 in the bottom surface as shown in FIGS. 4-6 and explained in more detail below. The ridges 12/grooves 22 are part of the fiberglass mold and help provide strength and rigidity by corrugation.

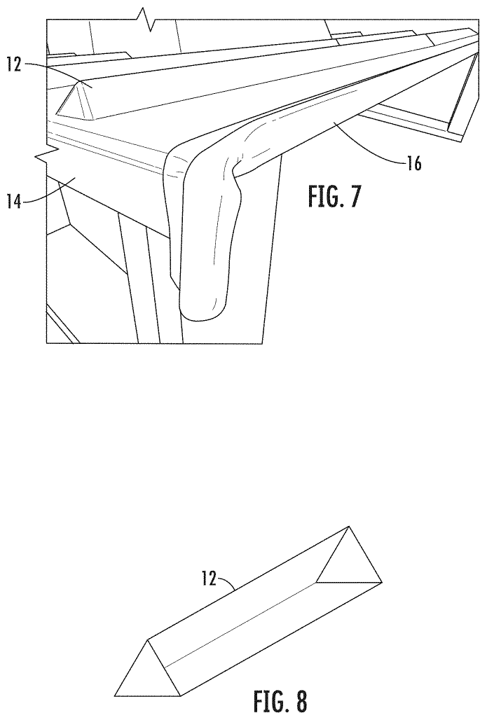

The pit cover 10 may be any suitable shape, however, the figures show an embodiment where the pit cover 12 has four sides comprising the front edge 17 and three other edges 19. Each of the other edges 19 has a flange 14 which acts as a handle to provide the user with a better grip when lifting or moving the pit cover 10. The flange 14 is shown best in FIGS. 1 and 7 wherein the flange 14 provides a height to the generally planer surface of the pit cover 10. The flange 14 extends downward beyond the bottom surface of the pit cover 10 so a user may grasp the front and rear surfaces of the flange 14 instead of the bottom surface of the pit cover 10. As explained above, front edge 17 includes a gasket 16 to help seal it against an adjacent structure such as the outer wall of the animal confinement building 11. An exemplary gasket 16 is shown in FIG. 7 wherein the gasket 16 is a soft compressible rubber material.

FIGS. 4-6 show the bottom side of the pit cover 10 wherein the grooves 22 are molded into the pit cover 10 and correspond with the ridges 12 shown in FIGS. 1 and 2. One or more reinforcing members 20 may be combined with the pit cover 10 to help add strength and rigidity. The reinforcing members 20 may be made of any suitable material, however, in one embodiment they are made of fiberglass. The reinforcing members 20 may extend in at least two directions. As shown, two reinforcing members 20 extending in a direction generally parallel with the longitudinal axis A-A of the front edge 17 and two reinforcing members 20 extend in a directly generally perpendicular to the longitudinal axis A-A of the front edge 17.

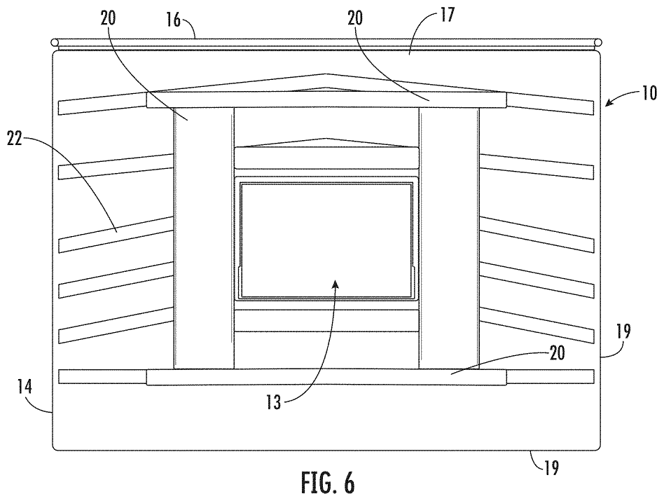

FIGS. 4-5 show an embodiment which includes filler 24 near the outer edges of the grooves 22. As explained above, the ridges 12 and corresponding grooves 22 help provide strength to the pit cover 10 through corrugation. The ridges 12/grooves 22 extend outward toward the outer edges of two of the other edges 19. It is beneficial for the pit cover 10 to be slightly larger than the frame 26 of the pit opening 27 so a user can grab the outer edges/flange 14 without interference from the frame 26. It is also beneficial for the pit cover 10 to seal against the frame 26 of the pit opening 27 to help prevent noxious gas from escaping. The dashed lines 26a shown in FIG. 5 represent the approximate location of where the pit's frame 26 would contact the pit cover 10 when the pit cover 10 is in place over the frame 26. As shown, the grooves 22 may extend outward beyond the frame 26. The filler 24 fills a portion of the grooves 24 near the area where the grooves 24 pass over the frame 26 to prevent gas from passing through the channel created by the groove 24 from one side of the frame 26 to the other side of the frame 26. Thus, the filler 24 allows the pit cover 10 to be corrugated while also providing a sufficient seal against the pit frame 26. FIG. 6 shows an alternate embodiment of the pit cover 10 wherein no filler 24 is used.

Having thus described the invention in connection with the preferred embodiments thereof, it will be evident to those skilled in the art that various revisions can be made to the preferred embodiments described herein with out departing from the spirit and scope of the invention. It is my intention, however, that all such revisions and modifications that are evident to those skilled in the art will be included with in the scope of the following claims.

### INFORMATION DISCLOSURE STATEMENT

1. DISCLOSE U.S. Pat. No. 7,491,265

What is claimed is as follows:

1. A pit cover for selectively covering an access opening to an animal waste collection area and adapted to be placed against an adjoining surface, said pit cover comprising:
a top side, a bottom side, a front edge, a first side and a second side, wherein the first side and the second side each have an outer edge;
wherein the front edge has a longitudinal axis and is adapted to be placed against the adjoining surface;
and wherein the top side comprises a plurality of ridges, each of the plurality of ridges having a longitudinal axis and extending upwardly from the top side.

2. The pit cover of claim 1 wherein the front edge has a sealing gasket adapted to create a seal between the pit cover and the adjoining surface.

3. The pit cover of claim 1 wherein the adjoining surface is an animal confinement building.

4. The pit cover of claim 1 wherein the plurality of ridges have a rounded apex.

5. The pit cover of claim 1 wherein the plurality of ridges have a pointed apex.

6. The pit cover of claim 1 wherein the plurality of ridges have a cross-section and the cross-section of the plurality of ridges is triangular.

7. The pit cover of claim 1 wherein the longitudinal axis of at least one of the plurality of ridges is generally parallel with the longitudinal axis of the front edge of the pit cover.

8. The pit cover of claim 1 wherein each of the plurality of ridges includes a first outer edge connected to a second and opposite outer edge by a middle portion, wherein the middle portion of at least one of the plurality of ridges is positioned closer to the front edge than the first outer edge and the second outer edge such that the at least one of the plurality of ridges is not parallel to the longitudinal axis of the front edge.

9. The pit cover of claim 1 wherein the longitudinal axis of one or more of the plurality of ridges is set at an angle relative to the longitudinal axis of the front edge of the pit cover.

10. The pit cover of claim 1 wherein the bottom side comprises grooves corresponding with the plurality of ridges and extending outwardly toward the outer edge of the first side and the second side.

11. The pit cover of claim 1 wherein said pit cover comprises a larger length and a larger width than the frame of the pit opening and is adapted to seal against a frame of a pit opening.

12. The pit cover of claim 10 wherein the grooves are configured to pass over the frame and comprise a filler configured to fill a portion of the grooves near the area where the grooves are configured to pass over the frame.

13. The pit cover of claim 1 wherein said pit cover comprises an opening wherein said opening extends upwardly through the top surface of the pit cover and is adapted to receive a fan.

14. The pit cover in claim 1 wherein the one or more other edges comprise a flange which extends downwardly beyond the bottom surface of the pit cover.

15. A pit cover for selectively covering an access opening to an animal waste collection area and adapted to be placed against an adjoining surface, said pit cover comprising:
a top side;
a bottom side comprising a plurality of grooves wherein said grooves are configured to pass over a frame and comprise a filler configured to fill a portion of the grooves near the area where the grooves are configured to pass over the frame;
a front edge comprising a longitudinal axis and is adapted to be placed against an adjoining surface and further comprising a sealing gasket adapted to create a seal between the pit cover and adjoining surface;
a first side and a second side, wherein the first side and the second side each have an outer edge, wherein said one or more of said outer edges comprise a flange which extends downwardly beyond the bottom surface of the pit cover;
a length larger than the frame of a pit opening; and
a width larger than the frame of the pit opening.

16. The pit cover of claim 15 wherein the adjoining surface is an animal confinement building.

17. The pit cover of claim 15 wherein said pit cover comprises an opening wherein said opening extends upwardly through the top surface of the pit cover and is adapted to receive a fan.

18. A pit cover for selectively covering an access opening to an animal waste collection area and adapted to be placed against an adjoining surface, said pit cover comprising:
a top side, wherein the top side comprises a plurality of ridges, each of the plurality of ridges having a longitudinal axis and extending upwardly from the top side and further wherein the longitudinal axis of one or more of the plurality of ridges is set at an angle relative to the longitudinal axis of the front edge of the pit cover;
a bottom side comprising a plurality of grooves wherein said grooves correspond with the ridges and wherein the grooves are configured to pass over the frame and comprise a filler configured to fill a portion of the grooves near the area where the grooves are configured to pass over the frame;
a front edge comprising a longitudinal axis and is adapted to be placed against an adjoining surface and further comprising a sealing gasket adapted to create a seal between the pit cover and adjoining surface;
one or more other edges, wherein said one or more other edges comprise a flange which extends downwardly beyond the bottom surface of the pit cover a length larger than a frame of a pit opening; and
a width larger than a frame of a pit opening.

19. The pit cover of claim 18 wherein the adjoining surface is an animal confinement building.

20. The pit cover of claim 18 wherein said pit cover comprises an opening wherein said opening extends upwardly through the top surface of the pit cover and is adapted to receive a fan.
